(19) United States
(12) Patent Application Publication
(10) Pub. No.: US 2006/0109752 A1
(43) Pub. Date: May 25, 2006

(54) Direct connection of a data storage device and a consumer electronic device

(76) Inventors: Bruce Armour, Elie (GB); Tony Combe, Dunfermline (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/528,127

(22) PCT Filed: Sep. 16, 2003
(86) PCT No.: PCT/GB03/04108

§ 371 Date: Nov. 3, 2005

(30) Foreign Application Priority Data
Sep. 16, 2002 (GB) 0221433.6

(51) Int. Cl. G11B 21/08

(52) U.S. Cl. 369/30.01

(57) ABSTRACT

An optical data storage device (10) adapted to act as a “host” or master on a peripheral interface (14) (e.g. Universal Serial Bus) allows easy (automatic and single button activated) storage of data from a consumer electronic device (16) such as Digital Still Camera (DSC) directly connected to the device on a standard optical storage medium (13) such as CD-R without the need for a (10) personal computer. The images are decompressed and stored (11) within the drive memory (22), re-compressed into a standard format, MPEG-1 (transcoded). The transcoded images are recorded onto the optical medium (13) in a format where each still image is written as a separate image frame. The standard format is compatible with the Video CD (or VCD) standard. This invention also provides a device comprising two peripheral interfaces and adapted (18) to act as a host on both, so that the separate or other form of data storage device including HDD or flash memory can be used.

This invention relates to data storage, in particular interface control and data recording for optical and other types of storage devices.

The storage of data files of all varieties on optical storage medium currently requires the use of a personal computer to control the interface between the storage medium and the source of the data to be stored. The present invention removes the requirement for the personal computer. Additionally the invention can be used to connect other forms of data storage.

The growth in digital consumer electronic devices over the last 5 years has been explosive. Increasing features available to the consumer has driven this growth. If the example of digital still camera (DSC) is considered, the consumer has been attracted by the ability to instantly view, delete and in some cases modify the pictures they have just taken, without the need for a “developing” stage. The consumer can further produce “photo quality” images with a low cost printer, connected to a personal computer (PC). Recent developments have seen the introduction of stand-alone printers, which can connect directly to a DSC, or can have the flash media typically used for the cameras connected directly to it. This removes the requirement for a PC for the printing images.

Archiving of the digital images produced is not done within the DSC or the flash media used within these cameras, due to the high costs, and limited size. Therefore the digital images are typically transferred to a PC for storage on a Hard Disc Drive (HDD), and are ultimately archived/backed-up in the form of optical data storage in a typical application.

There are two major problems for owners of digital cameras, namely the capacity size and cost of proprietary flash media cards that come with the digital cameras that they buy, and the ease of sharing and displaying the final images they have captured. This is due to lack of a “standard” and limitations of consumer electronics (CE) device compatibility.

It would be advantageous to remove the need for a personal computer to control the data transfer and the associated user-intervention.

It is an object of the present invention to provide direct connection of a storage device (such as a CD-RW or DVD RW drive or an HDD or flash memory) and a consumer electronic device.

According to a first aspect of the present invention, there is provided a storage device adapted to act as a “host” or master on a peripheral interface.

Preferably the storage device is an optical storage device.

Preferably there is provided a device comprising the storage device.

According to a second aspect of the present invention, there is provided device comprising:
a data writing means (12) to write data to a storage medium (13); and
a peripheral interface (14) for data transfer with a peripheral device (16) wherein the device acts as the “host”.

According to a third aspect of the present invention, there is provided a device, adapted to act as a “host” or master on a peripheral interface wherein the device is further adapted to automatically detect a connected peripheral and transfer data from the connected peripheral to a storage medium.

Preferably the device comprises:
a first peripheral interface (14) for data transfer with a peripheral device (16); and
a second peripheral interface (14) for data transfer with a storage device (38);
   wherein the device is adapted to act as “host” or master on the first and second peripheral interfaces.

Typically the storage medium is an optical medium.

Preferably the optical medium is an optical disc.

Optionally the device is further adapted to automatically delete the transferred file on the peripheral.

Optionally the device is further adapted to transfer the data responsive to a single user input.

Optionally the device is further adapted to verify the data transfer responsive to a single user input.

Optionally the device is further adapted to delete the transferred file responsive to a single user input.

Preferably the single user input is a single button press on the device.

Preferably a button on the device is dedicated to triggering one of: transferring, verifying or deleting data.

Preferably the device further comprises a peripheral interface host module (18) for providing host functions.

Preferably the host module is controlled by a firmware or coding module (20).

Preferably the format of the peripheral interface is a format for the transfer of data from peripheral device to a PC.

Optionally the device further comprises memory and the data comprises images and the device is further adapted to store decompressed images within the memory (22), transcoded into a standard format.

Preferably the transcoded images are recorded onto the storage medium in a format where each still image is written as a separate image frame.

Preferably the device is further adapted to transcode data received by peer to peer transfer and produce storage media of standard format.

Preferably the device further comprises a transcoder module (30) for converting data received from the peripheral device from a first format to a second format.

Optionally the device is adapted to save to the storage medium the data received from the peripheral device transcoded or copied directly into a plurality of formats.

Preferably the storage medium is an optical disc which is multi-session disc and each format is saved as a separate session.

According to a fourth aspect of the present invention, there is provided a method of storing data comprising the steps:
automatically detecting the connection of a peripheral;
receiving data from the connected peripheral; and
transferring the data to a storage medium.

Typically the storage medium is an optical medium.

Preferably the step of transferring is automatic.

Alternatively the step of transferring is responsive to a single user input.

Optionally the method further comprises the step of verifying the transferred file on the peripheral.

Preferably the step of verifying is automatic.

Alternatively the step of verifying is responsive to a single user input.

Optionally the method further comprises the step of deleting the transferred file on the peripheral.

Preferably the step of deleting is automatic.

Alternatively the step of deleting is responsive to a single user input.

Preferably the single user input is a single button press.

Preferably the single user input is a single button press on a button dedicated to triggering one of: transferring, verifying or deleting data.

Optionally the the data comprises an image and the method further comprises the steps of decompressing an image and transcoding it into a standard format.

Preferably the method further comprises the step of recording a plurality of transcoded images onto the storage medium in a format where each still image is written as a separate image frame.

Preferably the method further comprises the steps of transcoding data received by peer to peer transfer and producing storage media of standard format.

Optionally the method further comprises the step of saving to the storage medium the data received from the peripheral device transcoded or copied directly into a plurality of formats.

Preferably the method further comprises the step of saving each format as a separate session on a multi-session optical disc.

In order to provide a better understanding of the present invention, an embodiment will now be described by way of example only and with reference to the accompanying drawings, in which:

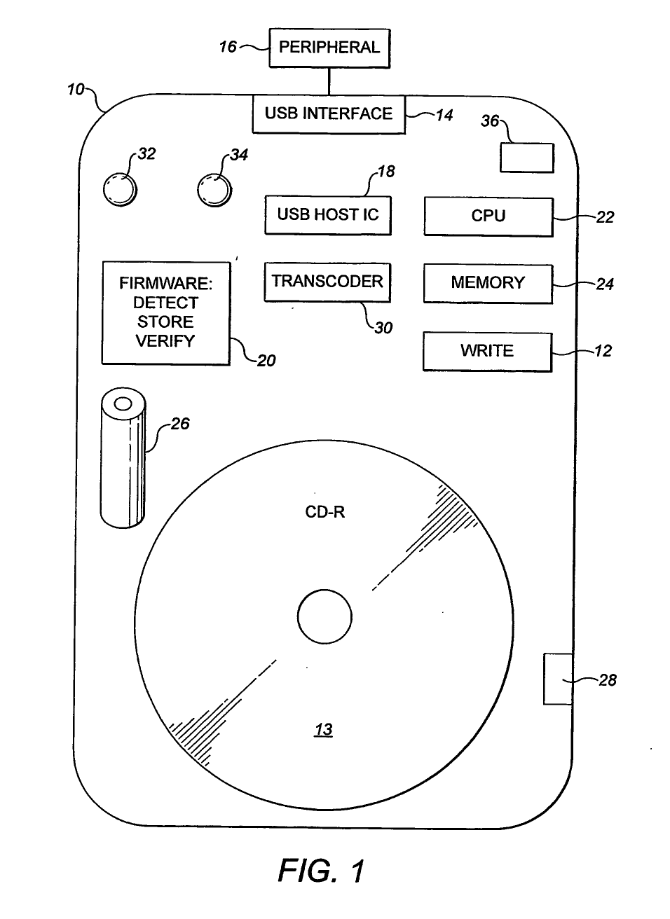

FIG. 1 illustrates, in schematic form a storage device, in accordance with a preferred embodiment of the present invention.

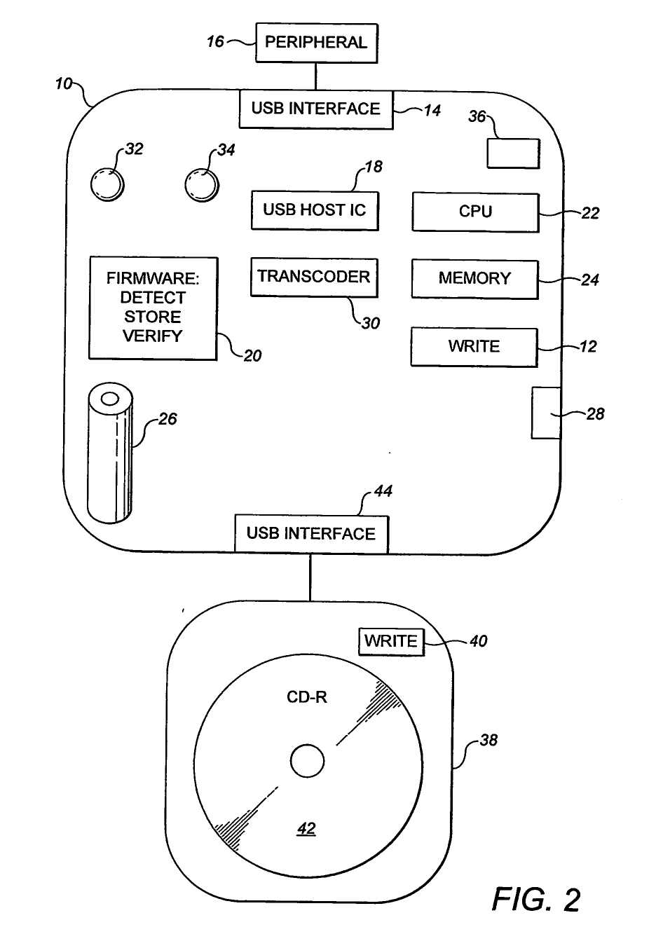

FIG. 2 illustrates, in schematic form a device with a separate storage device, in accordance with an alternative embodiment of the present invention.

The invention is an optical data storage device which can act as a “Host” or master device on a user interface (e.g. Universal Serial Bus—USB). Once the device can act as host, data files can be requested from the data source (e.g. a digital camera or Personal Data Assistant—PDA), and stored on the optical medium such as an optical disc without the need for a personal computer. This is known as peer to peer communications.

The invention also includes a method of transcoding data files received during peer-peer communications between an optical data storage device and a consumer electronic device, allowing the creation of an easily readable standard format data disc. The data disc produced can be in a number of formats. An example of an application is the creation of a Video Disc (standard format from Philips-Sony), or an ISO9660 disc which is again a standard format. An additional example would be the creation of a “multi-session” disc which had a session in the Video Disc format, and a session in the ISO9660 format. VCD allows maximum compatibility with consumer electronic devices, such as DVD-Video players.

With reference to FIG. 1, the optical data storage device (10) is shown. The device comprises:
a data writing means (12) to write data to an optical disc (13);
a peripheral interface (14) for data transfer to a peripheral device (16); and
wherein the optical data storage device acts as the “host”.

The optical data storage device comprises a peripheral interface host module (18) for providing host functions. This is a USB Host IC. The host module is controlled by a firmware stack or coding module (20).

The embedded firmware within the device allows automatic detection of a connected digital camera (or other storage device), and can be set-up to operate automatically, with the detected file stored to the destination drive (e.g. CDR) on detection of the camera. The device can further automatically verify that the written files match the source files, by performing a bit—bit compare. Another mode of operation requires the user to push a single button (32) after detection of the source (e.g. digital camera). This single button push enables the transfer of the data files and verification. A further mode of operation requires a button for data transfer (32) and one for verification (34). The buttons may be dedicated or soft keys. The status of the firmware (search for devices, transfer of data, verification) can be displayed via tri-colour LED's or via an LCD interface (36). The images may be deleted from the source device automatically or on a button press.

The embedded firmware is optimised to run on a low cost/low power processor (e.g. ARM7). The firmware comprises of an operating system which allows detection of the source of the data, as well as controlling the file structure creation on the destination storage (e.g. CD-R). This reduces the part count required and allows operation on low cost, portable products.

The format of the peripheral interface is a format for the transfer of data from peripheral device to a PC. The peripheral interface is the Universal Serial Bus, version 1.1 or Universal Serial Bus version 2.0.

The unit is powered from a battery supply (26) or via the peripheral connector (14) or from a separate supply (28).

The images are stored on the optical media in a format conforming to the ISO9660 standard.

The images are decompressed and stored within the drive memory (22), re-compressed into a standard format, MPEG-1 (transcoded).

Alternatively, the images may be transferred directly to the disc via the drive memory (22).

The transcoded images are recorded onto the optical media (13) in a format where each still image is written as a separate image frame. The standard format is compatible with the Video CD (or VCD) standard.

The peripheral device is a device which transfers digital data to a PC, e.g. a Digital Still Camera (DSC), a digital video camera, a personal digital assistant (PDA) or a mobile phone.

The device is further adapted to transcode data received by peer to peer transfer and produce optical discs of standard format. For this, the device further comprises a transcoder module (30) for converting data received from a peripheral from a first format to a second format.

The device is adapted to save to a disc (13) with the data received from a peripheral transcoded or copied directly into a plurality of formats. The discs may be multi-session discs with each format is saved as a separate session. Additionally the recording may span a number of discs if the required size is larger than a single disc.

The preferred embodiment is portable CD-RW with image download capability. The invention enables users to connect any USB digital stills camera directly to portable devices enabled with image download capability, such as 12 cm “Calypso” and 8 cm “Samba” portable CDR and CD-RW devices from Infinite Data Storage Ltd., Dunfermline, UK.

The present invention enables low cost CD storage and file sharing for users on the move. On a family holiday, there's no need to restrict the number of pictures you keep.

Instead of using expensive replacement flash cards or taking a laptop PC, you can burn as many as you like directly from your digital camera to CDs that cost as little as 50 cents each. You can use the CDs to archive your photos, and what's more they can be format compatible with your home DVD player, so you can simply view your images direct on a TV. No more PC.

The digital image download technology enables consumers with USB cameras to easily save images on very low cost media that can be accessed on a variety of PC and CE devices. Embedded software image format conversion in the CD-RW drive allows the creation of images on VCD or ISO 9660 compatible discs that can be played on any CD/DVD player or recorder. In addition the inclusion of MultiPhotoVideo compatibility further eases the accessing of pictures on home DVD video players. Applications that are normally only possible on PCs such as the mastering and burning of CDs can be completed on an embedded processor (22) such as the ARM7tdmi used in accordance with the present invention.

Thus the present invention allows easy storage of data on a standard optical storage medium without the need for a personal computer.

The present invention allows the creation of standard disc formats for data storage, without the need for a personal computer.

The present invention allows the creation of multi-session discs with the same data stored in different formats to maximise compatibility.

One example of application is the backup of digital images from a digital camera, whilst the user is travelling or unable to access a personal computer, or is looking for ease of use.

This invention removes the need for the PC, and allows creation of a copy and archival of the images produced within the camera on an optical medium. Additionally the images can be stored in different formats to allow easy use and inter-changeability of the stored images. Typical examples are storing the images in JPEG format (typical format of images from a DSC) and ISO9660 standard file structure. The ISO9660 standard allows easy interchange between types of PC (e.g. Intel based and Apple computers). Also provided according to the present invention is the ability to convert between one image encoding standard and another (transcoding), for example JPEG into an MPEG standard format, and the subsequent creation and recording of the files in a Video CD (or VCD) format/standard. The VCD format/standard allows the still images to be viewed within for example a suitably enabled DVD video player, thus removing the requirement for the DSC owner to also own a PC. Additionally this invention allows the creation of multiple copies of the same data for sharing etc.

The example given above is that for a DSC, but this could equally apply to other CE devices, such as personal digital assistants (PDA) or digital video cameras. Other CE devices that also connect and transfer digital data, images or audio could also be connected directly to such an optical data storage device.

Numerous other embodiments can be envisaged. For example, with reference to FIG. 2, simplification of the above embodiment can provide a device not having the data writing components (38) that comprise the data writing means (40), the optical disc (42) and the drive means for driving the disc (not shown). That is, the device comprises the peripheral interface (14), the peripheral interface host module (18), the firmware stack or coding module (20), the drive memory (22), the memory (24), the transcoder module (30), the battery supply (26) and separate supply (28), the buttons (32,34) and the display (36). The device further comprises at least one of another peripheral interface (44) like the above peripheral interface (14) in order to connect to another separate peripheral device, i.e. a data storage device such as CD-R or CD-RW drive, DVD or DVD-RW drive or recorder, HDD, or flash memory. The device acts as a host on both peripheral interfaces, and therefore control the separate data storage device (38) as well as the peripheral device (16) such as a Digital Still Camera.

This embodiment allows a use of various types of data storage devices including existing peripheral devices for PC. This is advantageous because the user can choose preferable one according to his purpose, and cost would be lower as the user can use the peripheral device which he has already had, and as the device itself would be simplified. Of course this embodiment does not diminish any advantages above-mentioned.

Further modifications and improvements may be added without departing from the scope of the invention herein described.

1.-40. (canceled)

41. A storage device adapted to act as a host on a peripheral interface.

42. The storage device as recited in claim 41, wherein the storage device is an optical storage device.

43. The storage device as recited in claim 41, further comprising:
data writing means for writing data to a storage medium; and
a peripheral interface configured to transfer data with a peripheral device, wherein the storage device acts as the host.

44. The storage device as recited in claim 41, wherein the storage device is further adapted to automatically detect a connected peripheral and transfer data from the connected peripheral to a storage medium.

45. The storage device as recited in claim 41, further comprising:
a first peripheral interface configured to transfer data with a peripheral device; and
a second peripheral interface configured to transfer data with the storage device, wherein the storage device is adapted to act as a host on the first and second peripheral interfaces.

46. The storage device as recited in claim 41, wherein the peripheral interface is configured to transfer data with a peripheral device.

47. The storage device as recited in claim 46, wherein the storage device is configured to automatically delete transferred data from a peripheral device.

48. The storage device as recited in claim 46, wherein the storage device is configured to transfer data responsive to a single user input.

49. The storage device as recited in claim 48, wherein the single user input is single button press on the storage device.

50. The storage device as recited in claim 46, wherein the storage device is configured to delete data stored in storage device responsive to a single user input.

51. The storage device as recited in claim 50, wherein the single user input is a single button press on the storage device.

52. The storage device as recited in claim 41, further comprising a button on the storage device, wherein the button is dedicated to triggering one of: transferring, verifying or deleting data.

53. The storage device as recited in claim 41, further comprising a peripheral interface host module for providing host functions.

54. The storage device as recited in claim 53, further comprising a coding module, wherein the peripheral interface host module is controlled by the coding module.

55. The storage device as recited in claim 41, wherein the format of the peripheral interface is a format for the transfer of data from a peripheral device to a personal computer.

56. The storage device as recited in claim 41, further comprising memory, wherein the storage device is further adapted to store decompressed images within the memory, transcoded into a standard format.

57. The storage device as recited in claim 56, further comprising a storage medium, wherein the transcoded images are recorded onto the storage medium in a format where each image is written as a separate image frame.

58. The storage device as recited in claim 41, wherein the storage device is adapted to transcode data received by peer to peer transfer and produce storage media of standard format.

59. The storage device as recited in claim 41, further comprising a transcoder module configured to convert data received from a peripheral device from a first format to a second format.

60. The storage device as recited in claim 41, further comprising a storage medium, wherein the storage device is adapted to save to the storage medium data received from a peripheral device transcoded directly into a plurality of formats.

61. The storage device as recited in claim 60, wherein the storage medium is a multi-session optical disc, wherein each format is saved as a separate session.

62. An electronic device for connecting a storage device to a peripheral device without requiring a personal computer, the device comprising:
a peripheral interface; and
a storage device in communication with the peripheral interface, wherein the storage device is adapted to act as a host on the peripheral interface.

63. The electronic device as recited in claim 62, wherein the peripheral interface is configured to transfer data with a peripheral device, wherein the storage device is further adapted to transfer the data responsive to a single user input.

64. The electronic device as recited in claim 63, wherein the single user input is a single button press on the storage device.

65. The electronic device as recited in claim 62, further comprising a peripheral interface host module configured to provide host function, wherein the peripheral interface host module is controlled by a coding module, wherein the format of the peripheral interface is a format for the transfer of data from a peripheral device to a personal computer.

66. A storage system for connecting a storage device to a peripheral device without requiring a personal computer, the system comprising:
a peripheral interface;
a storage medium configured to store data; and
a storage device in communication with the peripheral interface, wherein the storage device is adapted to: (i) act as a host on the peripheral interface; (ii) automatically detect a connected peripheral device; and (iii) transfer data from a connected peripheral device to the storage medium.

67. The storage system as recited in claim 66, wherein the storage device is further adapted to transfer data responsive to a single button press.

68. The storage system as recited in claim 66, wherein the storage device is further adapted to verify the data transfer responsive to a single user input.

69. The storage system as recited in claim 68, wherein the single user input is a single button press.

70. The storage system as recited in claim 69, wherein the button is dedicated to triggering one of: transferring, verifying or deleting data.

71. The storage system as recited in claim 66, wherein the storage device is further adapted to delete transferred data responsive to a single user input.

72. The storage system as recited in claim 71, wherein the single user input is a single button press.

73. The storage system as recited in claim 72, wherein the button is dedicated to triggering one of: transferring, verifying or deleting data.

74. The storage system as recited in claim 66, further comprising a peripheral interface host module configured to provide host function, wherein the peripheral interface host module is controlled by a coding module, wherein the format of the peripheral interface is a format for the transfer of data from a peripheral device to a personal computer.

75. A method of storing data comprising the steps:
automatically detecting the connection of a peripheral device;
receiving data from the connected peripheral device; and
transferring the data to a storage medium.

76. The method as recited in claim 75, wherein the storage medium is an optical medium.

77. The method as recited in claim 75, wherein the step of transferring the data is automatic.

78. The method as recited in claim 75, wherein the step of transferring the data is responsive to a single user input.

79. The method as recited in claim 75, further comprising the step of verifying the transferred data on the peripheral.

80. The method as recited in claim 79, wherein the step of verifying the transferred data is automatic.

81. The method as recited in claim 79, wherein the step of verifying the transferred data is responsive to a single user input.

82. The method as recited in claim 75, further comprising the step of deleting the transferred data on the peripheral.

83. The method as recited in claim 82, wherein the step of deleting the transferred data is automatic.

84. The method as recited in claim 82, wherein the step of deleting the transferred data is responsive to a single user input.

85. The method as recited in claim 84, wherein the single user input is a single button press.

86. The method as recited in claim 85, wherein the button is dedicated to triggering one of: transferring, verifying or deleting data.

87. The method as recited in claim 75, wherein the data comprises at least one image, and the method further comprises the steps of decompressing the image and transcoding it into a standard format.

88. The method as recited in claim 75, further comprising the step of recording a plurality of transcoded images onto the storage medium in a format where each image is written as a separate image frame.

89. The method as recited in claim 75, further comprising the steps of:
transcoding data received by peer to peer transfer; and
producing storage media of standard format.

90. The method as recited in claim 75, further comprising the step of saving to the storage medium the data received from the peripheral device transcoded directly into a plurality of formats.

91. The method as recited in claim 90, further comprising the step of saving each format as a separate session on a multi-session optical disc.
